(19) United States
(12) Patent Application Publication
(10) Pub. No.: US 2005/0207591 A1
(43) Pub. Date: Sep. 22, 2005

(54) Audio input unit, audio input method and audio input and output unit

(75) Inventors: Jungo Tsuji, Chiba (JP); Ryuji Suzuki, Tokyo (JP); Takashi Iwasa, Tokyo (JP); Michie Sato, Tokyo (JP)

Correspondence Address: DOYLE B. JOHNSON;REED SMITH LLP, Suite 2000, Two Embarcadero Center, San Francisco, CA, 94111, US

(73) Assignee: Sony Corporation

(21) Appl. No.: 11/131,692

(22) Filed: May 18, 2005

Related U.S. Application Data
(62) Division of application No. 10/241,494, filed on Sep. 11, 2002.

(30) Foreign Application Priority Data
Sep. 14, 2001 (JP) P2001-280028
Sep. 14, 2001 (JP) P2001-280029

(51) Int. Cl. H04R 3/00; H04R 1/02

(52) U.S. Cl. 381/92; 381/91; 381/122; 381/160

(57) ABSTRACT

A videoconferencing system uses an audio input unit including: two directional microphones disposed in directions with directivity being opposite to each other, the microphones forming a pair and a plurality of the pairs being located with directivity shifted from each other, cancellation elements for canceling sound components of the same phase from sounds inputted to the microphones of the pair, extraction elements for extracting sound components of voice band from sounds inputted to the microphones of the pair, a calculation element for calculating a difference between levels of the sound components of voice band extracted by the extraction elements to decide the microphone which has the larger level in the pair having the largest level difference, and selection elements for selecting sounds as input sound, in which the sound components with the same phase are canceled by the cancellation elements from sound inputted to the microphone decided by the calculation element.

### BACKGROUND OF THE INVENTION

1. Field of the Invention

The present invention relates to an audio input unit, an audio input method and an audio input and output unit for use in a remote conference system such as a videoconferencing system.

2. Description of the Related Art

Many departments or companies have so far introduced systems by which participants at a plurality of remote locations can attend a meeting by sending and receiving audio signals transmitted through a high-speed line.

FIG. 1 of the accompanying drawings is a block diagram showing an outline of a videoconferencing system which is a kind of such remote conference systems. As shown in FIG. 1, a meeting room Ra includes a microphone 101a, a speaker 102a, an echo canceller 103a, a video camera 104a, a projector 105a, a codec 106a and a DSU (Digital Service Unit) 107a.

As shown in FIG. 1, a meeting room Rb at a location remote from the meeting room Ra includes a microphone 101b, a speaker 102b, an echo canceller 103b, a video camera 104b, a projector 105b, a codec 106b and a DSU 107b as well. The DSU 107a and the DSU 107b are connected to each other through a dedicated line 108 or an ISDN 109.

The echo cancellers 103a, 103b are adapted to suppress echo caused by a phenomenon in which sounds inputted to microphones of one side are again outputted from the speakers of its own side after the sounds have been outputted from the speakers of another side and inputted to the speaker of another side, and to suppress howl caused by such echo. The echo cancellers 103a, 103b are constituted by installing, for example, digital filter software in a DSP (Digital Signal Processor).

A voice of a participant in the meeting room Ra is inputted to the microphone 101a and outputted from the speaker 102b in the meeting room Rb through the echo canceller 103a, the codec 106a, the DSU 107a, the dedicated line 108 or the ISDN 109, the DSU 107b, the codec 106b and the echo canceller 103b, sequentially. A voice of a participant in the meeting room Rb is also inputted to the microphone 101b and outputted from the speaker 102a in the meeting room Ra.

A known system to hold a meeting by sending and receiving voices among a plurality of remote locations through a high-speed line like this videoconferencing system (referred to as a “remote location meeting system” in this specification) has so far employed the following system (1), (2) or (3) as a system for inputting voices of participants through microphones when a plurality of participants are sitting at one location.

(1): One non-directional microphone is set in a meeting room and sound inputted to this non-directional microphone is directly supplied to an echo canceller.

(2): A plurality of directional microphones as a whole are set at the center of a table at which participants are sitting in such a manner that voices from all participants may be inputted to the microphones (voices from every part of seats can be inputted to individual directional microphone). Voices inputted to the respective directional microphones are synthesized and supplied to an echo canceller.

(3): A plurality of directional microphones as a whole are set at the center of a table at which participants are sitting in such a manner that voices from all participants may be inputted to the microphones (voices from every part of seats can be inputted to individual directional microphone). Then, a microphone to which sound of level exceeding a predetermined reference level (ordinary noise level within the meeting room) is inputted is selected from these directional microphones and only the sound inputted to the microphone is supplied to the echo canceller.

So far this remote location meeting system has often employed a unit in which a microphone and a speaker are integrally formed as one body (in FIG. 1, the microphone 101a and the speaker 102a are integrally formed as one body and the microphone 101b and the speaker 102b are integrally formed as one body). In the following description, this unit will be referred to as a “microphone/speaker integrated unit” for simplicity.

FIG. 2A is a perspective view showing an example of an arrangement of a microphone/speaker integrated unit according to the related art, and FIG. 2B is a perspective view showing a place where the microphone/speaker integrated unit shown in FIG. 2A is set. As shown in FIG. 2A, in this microphone/speaker integrated unit, a speaker 121 is disposed with its front axis being upwardly faced toward the vertical direction, while a plurality of microphones 122 are disposed around the speaker 121 with the fronts being faced toward the horizontal direction (although only one microphone is shown in FIG. 2A because of the angle at which the microphone/speaker integrated unit is seen, an LED (light-emitting diode) lamp 123 for displaying the on and off state of the microphone is provided at the upper side of each microphone and three LED lamps 123 with respect to the three microphones 122 are shown in FIG. 2A). As shown in FIG. 2B, this microphone/speaker integrated unit 124 is set at the center of a table 125 at which participants are sitting in the meeting room.

FIG. 3A is a front view showing another example of an arrangement of a microphone/speaker integrated unit according to the related art. FIG. 3B is a perspective view showing a place where the microphone/speaker integrated unit shown in FIG. 3A is set. As shown in FIG. 3A, this microphone/speaker integrated unit includes a speaker 126 whose front axis is faced toward the horizontal direction, a microphone 127 whose front is faced toward the same direction as that of the speaker 126 and a video camera 128 whose image-pickup lens is faced toward the same direction as that of the speaker 126, all of which are integrally formed as one body. As shown in FIG. 3B, this microphone/speaker integrated unit 129 is set at a corner of the table 125 in such a manner that it may be faced toward the center of the table 125.

FIG. 4 is a perspective view showing a further example of an arrangement of a microphone/speaker integrated unit according to the related art and a place where such microphone/speaker integrated unit is set. This microphone/speaker integrated unit may be used by each participant in the meeting. As shown in FIG. 4, this microphone/speaker integrated unit includes a speaker 130, a microphone 131 and an operation switch 132 for turning on and turning off the microphone 131. The microphone/speaker integrated unit is set in front of the seat of each participant (a control unit 133 for use in the videoconferencing system is set at a corner of the table 125, each microphone/speaker integrated unit is connected to the control unit 133 and a video camera 134 is set on the control unit 133 such that it may be faced toward the center of the table 125).

The above-mentioned known systems (1) to (3), however, encounter with the following disadvantages.

Specifically, according to the above-mentioned system (1), while the level at which a voice of a participant sitting at the seat close to the non-directional microphone (approximately within 1 meter) is inputted to the non-directional microphone is large as an absolute amount and also which is large as a relative ratio to the input level of other background noise, the level at which a voice of a participant sitting at the seat distant from the non-directional microphone (approximately longer than 1 meter) is inputted to the non-directional microphone is considerably low as an absolute amount and also which is considerably low as a relative ratio to the input level of other background noise. Therefore, the voice of the participant at the seat distant from the non-directional microphone is not efficiently collected by the non-directional microphone. As a result, when the participant seating distant from the non-directional microphone speaks, the voice of the speaking participant cannot be emanated clearly from the speaker in another meeting room at the remote location. Then, there is a risk that the meeting cannot progress smoothly.

As an improved example of the known system (1), if an auxiliary microphone that can be turned on and off by operation buttons is set near the seat of the participant distant from the non-directional microphone and this microphone is turned on when the participant speaks, the above-mentioned disadvantage can be removed. However, the microphone should be turned on and off each time the participant speaks. Moreover, since the positions at which the microphones are to be set and the number of microphones that should be set have to be changed in response to the positions at which the participants are seated and the number of participants at the meeting. Accordingly, there arises a new disadvantage that operations of the microphone and the work for setting the microphones will become cumbersome for users.

Next, according to the known system (2), while a voice of each participant is inputted to one or two directional microphones at most, noises (sounds from an air-conditioner, sounds from a radiation fan of a projector, etc.) spread to the entire meeting room are inputted to all directional microphones and thereby synthesized, so that a sound signal supplied to an echo canceller increases the level of noise relative to the level of a voice of a participant than an actual level. As a result, a voice of the participant cannot be clearly emanated from the speaker in another meeting room at a remote location. There is then a risk that the meeting cannot progress smoothly.

In the above-mentioned system (3), when particular noises (e.g., sounds produced when someone turns over the pages in front of the directional microphone, sounds produced when a door is opened or shut in front of the directional microphone, etc.) of high level are inputted to only one directional microphone, this directional microphone is selected, so that the speaker in another meeting room at a remote location emanates mainly such noises. As a consequence, a voice of the participant cannot be clearly outputted from the speaker in another meeting room at a remote location. There is then a risk that the meeting cannot progress smoothly.

Further, the microphone/speaker integrated units shown in FIGS. 2 to 4 according to the related-art cannot avoid the following disadvantages.

In the microphone/speaker integrated unit shown in FIG. 2, since sounds are upwardly outputted from the speaker 121, the sounds reached the ears of the participants after they had been reflected on the ceiling or wall of the meeting room. As a result, the participants in one meeting room cannot clearly hear a voice of the participant in another meeting room at a remote location (when someone in one meeting room is speaking, a voice of someone cannot be distinctly outputted from the speaker 126 of the microphone/speaker integrated unit 129 in another meeting room at a remote location). There is a risk that the meeting cannot progress smoothly.

In general, when the power switch of the microphone/speaker integrated unit having the arrangement shown in FIG. 2 is turned on, all the microphones 122 are turned on so that noises (sounds from the air-conditioner, sounds from the radiation fan of the projector, etc.) spread to the entire meeting room are all inputted to the microphone and thereby synthesized. As a consequence, since the level of the noise relative to the level of the voice of a participant increases than an actual one, from this point of view, the speaker 126 of the microphone/speaker integrated unit 129 in another meeting room at a remote location becomes unable to distinctly output the voice of the participant.

Moreover, in the microphone/speaker integrated unit shown in FIG. 2, the sound outputted from the speaker 121 is leaked toward the microphone 122 and inputted to the microphone 122. Therefore, since the echo cancellers (echo cancellers 103a, 103b in FIG. 1) are requested to have high capabilities to suppress echo or howl, a burden imposed upon development of software executed by the DSP comprising the echo canceller unavoidably increases and a cost of a hardware circuit used as an echo canceller also increases.

Next, in the microphone/speaker integrated unit shown in FIG. 3, when many participants are attending the meeting (when the table 125 is large), the level at which a voice of a participant distant from the microphone/speaker integrated unit 129 is inputted into the microphone 127 decreases as an absolute amount and also decreases as a relative ratio to the input level of other background noises. Therefore, a voice of the participant distant from the microphone/speaker integrated unit 129 is not collected efficiently by the microphone 127. Accordingly, when the participant distant from the microphone/speaker integrated unit 129 is speaking, since a voice of the participant cannot be outputted clearly from the speaker 126 of another microphone/speaker integrated unit 129 at a remote location, there is a risk that the meeting cannot progress smoothly.

In the microphone/speaker integrated unit shown in FIG. 3, since the sound outputted from the speaker 126 is leaked toward the microphone 127 and inputted to the microphone 127, the echo canceller is requested to have a high capability. As a result, it is unavoidable that a burden imposed upon development of the echo canceller increases and that a cost of a hardware circuit used as the echo canceller increases.

Further, when many participants are attending a meeting (when the table 125 is large), the output level of the speaker 126 should be increased in order to enable the participant distant from the microphone/speaker integrated unit 129 to catch the sounds generated from the speaker 126 clearly. However, when the output level of the speaker 126 increases, since the level at which the sound leaked from the speaker 126 toward the microphone 127 and inputted into the microphone 127 also increases, the echo canceller is further requested to have a high capability.

When the microphone/speaker integrated unit 129 is not set at the corner of the table as shown in FIG. 3B but is set at the center of the table 125, since voices of participants seated in the rear and side directions of the microphone/speaker integrated unit 129 are not efficiently collected by the microphone 127, the speaker 126 of another microphone/speaker integrated unit 129 at a remote location cannot clearly output the voices of the participants sitting in those directions.

Even when the microphone/speaker integrated unit 129 is set at the center of the table 125, the output level of the speaker 126 should be increased in order to enable the participants seated in the rear and side directions of the microphone/speaker integrated unit 129 to catch the sounds generated from the speaker 126 clearly. As a result, the echo canceller is further requested to have a high capability.

Next, in the microphone/speaker integrated unit shown in FIG. 4, since the microphones 131 and the speakers 130 exist near individual participants, the participants can distinctly catch the voices of the participants in another meeting room at a remote location.

However, many microphone/speaker integrated units should be provided in accordance with the number of the participants and hence a cost of the audio input unit increases inevitably.

Further, since the participant who is to speak has to turn on the microphone 131 by operating the operation switch 132 before the participant begins to speak and also the participant has to turn off the microphone 131 by operating the operation switch 132 after the participant has finished speaking, such operations for turning on or off the switch 132 become cumbersome for users.

In addition, since the positions at which the microphone/speaker integrated units are set and the necessary number of microphone/speaker integrated units are changed in response to the positions at which the participants are seated and the number of participants, a work for setting the microphones become troublesome for users.

Also in the microphone/speaker integrated unit shown in FIG. 4, since the sound outputted from the speaker 130 is leaked toward the microphone 131 and inputted into the microphone 131, the echo canceller is requested to have a high capability so that a burden imposed upon development of the echo canceller increases and that a cost of the audio input unit also increases.

### SUMMARY OF THE INVENTION

In view of the aforesaid aspects, it is an object of the present invention to provide an audio input unit, an audio input method and an audio input and output unit in which a voice of a participant can constantly be outputted clearly from another speaker at a remote location in a remote location meeting system such as a videoconferencing system.

It is another object of the present invention to provide an audio input unit, an audio input method and an audio input and output unit in which operations for turning on and off microphones and a work for setting microphone can be simplified and prevented from becoming cumbersome.

It is a further object of the present invention to provide an audio input unit, an audio input method and an audio input and output unit in which a burden imposed upon developing a highly efficient echo canceller and a cost can be decreased.

According to an aspect of the present invention, there is provided an audio input unit including two directional microphones disposed in directions with directivity being opposite to each other, the two directional microphones forming a pair and a plurality of the pairs being located in directions with directivity being shifted from each other, comprising: cancellation means for mutually canceling sound components of the same phase from sounds inputted to the two directional microphones of the pair, extraction means for extracting sound components of a voice band from sounds inputted to the directional microphones of the pair, calculation means for calculating a difference between levels of sound components of the voice band extracted by the extraction means with respect to the two directional microphones of the pair and deciding a directional microphone having the larger level in the pair which has the largest level difference and selection means for selecting sounds, in which by the cancellation means the sound components with the same phase are canceled from sound inputted to the directional microphone decided by the calculation means, as a voice to be inputted.

In this audio input unit, the two directional microphones disposed in directions with directivity being opposite to each other (i.e., having high sensitivity relative to sounds introduced from the directions opposite to each other) constitute one pair. Then, a plurality of pairs are located in directions with directivity being shifted from each other (with sensitivity relative to sounds introduced from the directions different from each other).

The cancellation means cancels sound components of the same phase from the sounds inputted to the two directional microphones in the same pair. Thus, noises spread to the entire meeting room (sounds from an air-conditioner, sounds from a radiation fan of a projector, etc.) are canceled from the sounds inputted to the two directional microphones.

Also, the extraction means extracts sound components of respective voice bands from the sounds inputted into the directional microphones of each pair. Then, the calculation means calculates a difference between the inputted levels of the sound components of the voice band and selects a directional microphone having the larger level from the pair having the largest level difference. As a result, one microphone which is collecting a voice of a currently speaking participant at highest efficiency is decided from the directional microphones of each pair.

Accordingly, there is selected the sound in which sound components of the same phase (noises spread to the entire meeting room) are canceled by the selection means from the sound inputted from the directional microphone selected by the calculation means (microphone which collects a voice of a currently speaking participant at highest efficiency) as an input voice.

As described above, according to this audio input unit, the microphone is not selected based upon the levels of the sounds inputted into the individual microphones, but the microphone which collects the voice of the currently speaking participant at highest efficiency is selected based upon the difference between the inputted levels of the sound components of the voice band with respect to the two directional microphones of each pair, and the sound in which the noise spread to the entire meeting room is canceled from the sound inputted into the selected microphone is selected as the input voice.

Consequently, in the remote location meeting system such as the videoconferencing system, the speaker in another meeting room at a remote location can constantly output a voice of a participant clearly. Since this inputted voice is selected automatically, operations for turning on and off the microphone can be simplified. Moreover, since it is only necessary to set the directional microphones of each pair of this audio input unit at the center of the table at which participants are sitting, for example, a work for setting the microphones can be prevented from becoming cumbersome.

It is preferable that this input unit further comprises: for example, a plurality of image-pickup means whose fronts are directed approximately in the same directions as the directions in which the pair of the directional microphones have directivity and selection means for selecting an image picked up by image-pickup means whose front is directed toward approximately the same direction as the direction in which the directional microphone determined by the calculation means has directivity.

Thus, a picture (i.e., picture in which the participant is seen best) picked up by the image pickup means, which is faced toward approximately the same direction as the direction in which the microphone collecting the voice of the currently speaking participant at highest efficiency has directivity, is selected automatically.

Accordingly, when only one camera is set in each meeting room, the camera has to be faced toward the currently speaking participant in a manual fashion in the videoconferencing system. According to the aspect of the present invention, such troublesome camera work is not required and the meeting will progress more smoothly.

According to another aspect of the present invention, there is provided an audio input method comprising the steps of: locating two directional microphones in directions with directivity being opposite to each other, the two directional microphones forming a pair and a plurality of the pairs being located in directions with directivity being shifted from each other, canceling sound components of the same phase from sounds inputted to the two directional microphones of the pair, extracting sound components of the voice band from sounds inputted to the directional microphones of the pair, calculating a difference between sound components of the voice band extracted by the extracting step with respect to the two directional microphones of the pair and deciding a directional microphone having the larger level in the pair which has the largest level difference and selecting sounds, in which by the canceling step the sound components with the same phase are canceled from sound inputted to the directional microphone decided by the calculating step, as input voice.

According to this audio input method, in exactly the same way as the aforementioned audio input unit according to the present invention, in the remote location meeting system such as the videoconferencing system, the speaker in another meeting room at a remote location can constantly output a voice of a participant clearly, and operations for turning on and off the microphone and a work for setting the microphones can be prevented from becoming cumbersome.

It is also preferable that this audio input method further comprises the steps of: locating a plurality of image-pickup means whose fronts are directed approximately in the same directions as the directions in which the pair of the directional microphone have directivity and selecting an image picked up by image-pickup means whose front is directed toward approximately the same direction as the direction in which the directional microphone decided by the calculating step has directivity.

According to this audio input method, since the picture in which the currently speaking participant is seen best is selected automatically, the meeting will progress more smoothly.

According to a further aspect of the present invention, there is provided an audio input and output unit (microphone/speaker integrated unit) comprising: a plurality of directional microphones disposed above a speaker such that the microphones are faced toward directions with directivity being approximately perpendicular to a front axis of the speaker, a reflective member provided between the speaker and the plurality of directional microphones to reflect sounds outputted from the speaker in the direction approximately perpendicular to a front axis of the speaker, and a shielding member provided between the speaker and the plurality of directional microphones for separating the speaker and the plurality of directional microphones from each other.

In this audio input and output unit, the reflective member for reflecting the sounds outputted from the speaker in the direction approximately perpendicular to the front axis of the speaker exists between the speaker and a plurality of directional microphones. Accordingly, when this audio input and output unit is set at the table in the meeting room such that the front axis of the speaker may be faced toward the vertical direction, the sounds from the speaker are reflected in the approximately horizontal direction by this reflective member.

Consequently, since the sounds from the speaker reach the participant's ears without reflecting on the ceiling or walls of the meeting room and, the speaker in another meeting room at a remote location can output the clear voice of the participant.

Moreover, in this audio input and output unit, a plurality of directional microphones are provided in such a manner that the microphones are faced toward directions with directivity being approximately perpendicular to the front axis of the speaker. Therefore, when this audio input and output unit is set on the table in the meeting room such that the front axis of the speaker is faced toward the vertical direction, the directions in which these directional microphones have directivity are approximately the horizontal direction (direction toward the participants at the table).

Consequently, since these directional microphones can collect voices of respective participants at high efficiency, the voice of the participant can be clearly outputted from the speaker of another audio input and output unit at a remote location.

Moreover, since it is only necessary to set this audio input and output unit at the center of the table at which participants are sitting, for example, a cost can be decreased and a work for setting the microphones and the operation can be prevented from becoming cumbersome.

Further, in this audio input and output unit, since the shielding member for separating the speaker and a plurality of directional microphones exists between the speaker and these directional microphones, the amount of sounds leaked toward these directional microphones of sounds outputted from the speaker can be decreased considerably. Therefore, since the level at which the sound from the speaker is inputted to the directional microphone is lowered considerably, echo and howl can be suppressed considerably without the processing of the echo canceller.

As a result, since the echo canceller itself is not required to have higher capability, a burden imposed upon development of software executed by a DSP comprising the echo canceller can be alleviated and a cost of a hardware circuit used as the echo canceller can be decreased.

Further, since the level at which the sound from the speaker is inputted into the directional microphone is lowered, a voice of a participant can be collected by the directional microphone at high efficiency.

The reflective member may include, for example, a conical member with the vertex of the circular cone thereof being faced toward the direction of the speaker, disposing a central axis of the circular cone approximately aligned with the front axis of the speaker.

Further, in this audio input and output unit, it is preferable that, for example, a plurality of directional microphones may comprise a pair of directional microphones disposed in directions with directivity being opposite to each other and a plurality of the pairs are located in directions with directivity being shifted from each other.

When the audio input and output unit in which a plurality of directional microphones are disposed as described above is set at the center of the table in the meeting room, voices of participants can be collected by these directional microphones more efficiently.

### BRIEF DESCRIPTION OF THE DRAWINGS

FIG. 1 is a block diagram showing an outline of a general videoconferencing system;

FIG. 2A is a perspective view showing an arrangement of a microphone/speaker integrated unit according to the related art;

FIG. 2B is a pictorial perspective representation showing the manner in which the microphone/speaker integrated unit shown in FIG. 2A is to be set in a meeting room;

FIG. 3A is a front view showing an arrangement of a microphone/speaker integrated unit according to the related art;

FIG. 3B is a pictorial perspective representation showing the manner in which the microphone/speaker integrated unit shown in FIG. 3A is to be set in a meeting room;

FIG. 4 is a perspective view showing an arrangement of a microphone/speaker integrated unit according to the related art and the manner in which the microphone/speaker integrated units are to be set in a meeting room;

FIG. 5 is a front view showing, partly in a cross-sectional fashion, an outward appearance of a microphone/speaker portion of an audio input and output unit to which the present invention can be applied;

FIG. 6 is a plan view showing an outward appearance of a microphone/speaker portion of an audio input and output unit to which the present invention can be applied;

FIG. 7 is a perspective view schematically showing a microphone/speaker portion of an audio input and output unit to which the present invention can be applied;

FIG. 8 is a block diagram showing a circuit arrangement of a signal processing system of an audio input and output unit to which the present invention can be applied;

FIG. 9 is a flowchart for explaining processing executed-by a calculating circuit shown in FIG. 8;

FIG. 10 is a block diagram showing an outline of a videoconferencing system using an audio input and output unit to which the present invention can be applied;

FIG. 11 is a perspective view showing the position where the audio input and output unit is to be set in the videoconferencing system shown in FIG. 10;

FIG. 12 is a schematic diagram showing a positional relationship between a participant and microphones;

FIG. 13 is a front view showing, partly in a cross-sectional fashion, a first modified example of an audio input and output unit to which the present invention can be applied;

FIG. 14 is a schematic block diagram showing a second modified example of an audio input and output unit to which the present invention can be applied;

FIG. 15 is a flowchart for explaining the processing executed by a DSP shown in FIG. 14;

FIG. 16 is a front view showing, partly in a cross-sectional fashion, a third modified example of an audio input and output unit to which the present invention can be applied;

FIG. 17 is a plan view showing the third modified example of the audio input and output unit to which the present invention can be applied;

FIG. 18 is a schematic block diagram showing the third modified example of the audio input and output unit to which the present invention can be applied;

FIG. 19 is a block diagram showing the third modified example of the audio input and output unit to which the present invention can be applied;

FIG. 20 is a plan view showing a fourth modified example of an audio input and output unit to which the present invention can be applied;

FIG. 21 is a plan view showing the fourth modified example of the audio input and output unit to which the present invention can be applied;

FIG. 22 is a plan view showing a fifth modified example of an audio input and output unit to which the present invention can be applied; and

FIG. 23 is a plan view showing the fifth modified example of the audio input and output unit to which the present invention can be applied.

### DESCRIPTION OF THE PREFERRED EMBODIMENTS

The present invention will be described concretely with reference to the drawings.

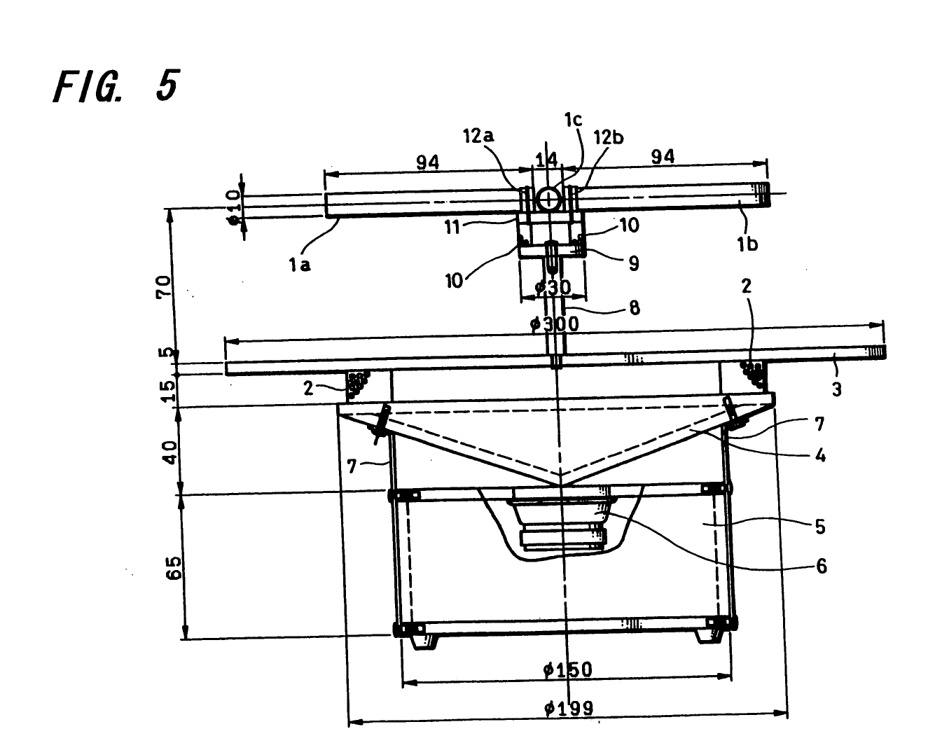

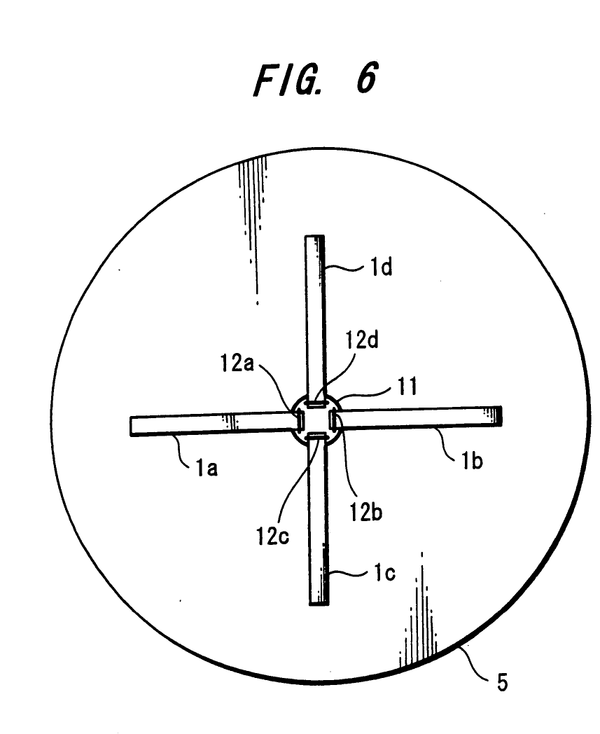

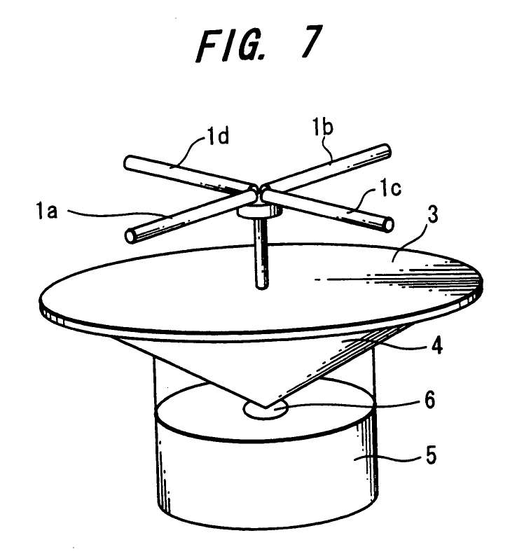

FIGS. 5 and 6 are a front view (partly in a cross-sectional fashion) and a plan view showing an outward appearance of a microphone/speaker portion of an audio input and output unit to which the present invention can be applied, respectively. FIG. 7 is a perspective view schematically showing an outward appearance of this microphone/speaker portion.

This audio input and output unit is a unit that can be used in a remote location meeting system such as a videoconferencing system, in which a microphone and a speaker are integrally formed (that is, a unit in which a microphone for inputting a voice of a participant within a meeting room and a speaker for outputting a voice of a participant in another meeting room are integrally formed as one body).

As illustrated, in this audio input and output unit, a dynamic speaker 6 is accommodated within a cylindrical enclosure 5 having a diameter of approximately 150 mm in such a manner that the front axis of the dynamic speaker 6 is upwardly faced toward the vertical direction.

On the upper edge portion of the enclosure 5, long supports 7 which are extending in the vertical direction are attached to two places symmetrical to the front axis of the speaker 6, respectively. The long supports 7 may be made of resin or metal having rigidity. On the upper side of the enclosure 5A, reflective plate 4 of a circular cone shape having a diameter of approximately 199 mm is attached to the upper end portions of the supports 7 by screws in such a manner that a vertex of the circular cone is faced toward the downward direction and that the central axis of the circular cone is approximately aligned with the front axis of the speaker 6.

A distance from the vertex of the reflective plate 4 to the position at which the reflective plate 4 is attached to the upper end portions of the supports 7 by screws, with respect to the central axis direction, is slightly shorter than the height of the support 7. As a consequence, the vertex of the reflective plate 4 can be brought to the position sufficiently close to a diaphragm of the speaker 6 within a range not in contact with the diaphragm of the speaker 6. The reflective plate 4 is made of ABS (acrylonitrile-butadiene-styrene) resin.

As shown in FIG. 5, a disk-like shielding plate 3 having a diameter of approximately 300 mm is attached to the upper side of the reflective plate 4 across a cushion material 2 in such a manner that its plate surface is approximately located within a horizontal plane and that the central axis of the disk is approximately aligned with the central axis of the reflective plate 4. This disk-like shielding plate 3 is also made of ABS resin.

The shielding plate 3 has a through hole at its central portion of the plate surface, and a columnar support 8 (made of resin or metal having rigidity) extending in the vertical direction is attached to the upper side of the shielding plate 3 such that its lower end portion is extended through this hole. A disk-like member 9 (made of resin or metal having rigidity) having a diameter of approximately 30 mm is attached to the upper end portion of the support 8 in such a manner that the central axis of the disk is approximately aligned with the central axis of the support 8.

A disk-like member 11 (made of resin or metal having rigidity) having a diameter of approximately 30 mm is attached to the upper side of the member 9 in such a manner that the central axis of the disk is approximately aligned with the central axis of the support 8. A distance from the lower end portion of the support 8 to the upper end portion of the member 11 along the vertical direction is approximately 65 mm.

A pair of holes are bored through the peripheral edge portion of the plate surface of the member 11 at its four places which are distant at equal intervals from each other, and latches 12a to 12d having annular portions are attached to the member 11 through the above-mentioned four holes.

As shown in FIG. 6, a unidirectional microphone (hereinafter simply referred to as a “microphone”) 1a having a length of approximately 94 mm and a diameter of approximately 10 mm and which has directivity in the front direction is held within the approximately horizontal plane of the disk-like member 11 at its rear end portion latched by the latch 12a in such a manner that its front is nearly opposite to the central axis of the disk-like member 11 as seen from the latch 12a.

A microphone 1b of the same type as the microphone 1a is held within the approximately horizontal plane of the disk-like member 11 at its rear end portion latched by the latch 12b located at the symmetrical position to the latch 12a with respect to the central axis of the disk-like member 11 in such a manner that its front is nearly opposite to the central axis of the disk-like member 11 as seen from the latch 12b (i.e., the directivity is set to the opposite direction of the microphone 1a).

A microphone 1c of the same type is held within the approximately horizontal plane of the disk-like member 11 at its rear end portion latched by the latch 12c in such a manner that its front is nearly opposite to the central axis of the disk-like member 11 as seen from the latch 12c (i.e., the directivity is shifted by 90° from that of the microphone 1a or 1b).

A microphone 1d of the same type is held within the approximately horizontal plane of the disk-like member 11 at its rear end portion latched by the latch 12d located at the symmetrical position to the latch 12c with respect to the central axis of the disk-like member 11 in such a manner that its front is nearly opposite to the central axis of the disk-like member 11 as seen from the latch 12d (i.e., the directivity is shifted by 90° from that of the microphone 1a or 1b and also is set to the opposite direction of the microphone 1c).

As described above, and as shown in FIG. 7, in this audio input and output unit, a pair of microphones (referred to as a “pair A”) comprising the two unidirectional microphones 1a and 1b located in directions with directivity being opposite to each other and a pair of microphones (referred to as a “pair B”) comprising the two unidirectional microphone 1c and 1d located in directions with directivity being opposite to each other are disposed above the upper side of the speaker 6 whose front axis is faced toward the vertical direction through the reflective plate 4 and the shielding plate 3 in such a manner that directivity of the microphones are shifted by approximately 90° from each other.

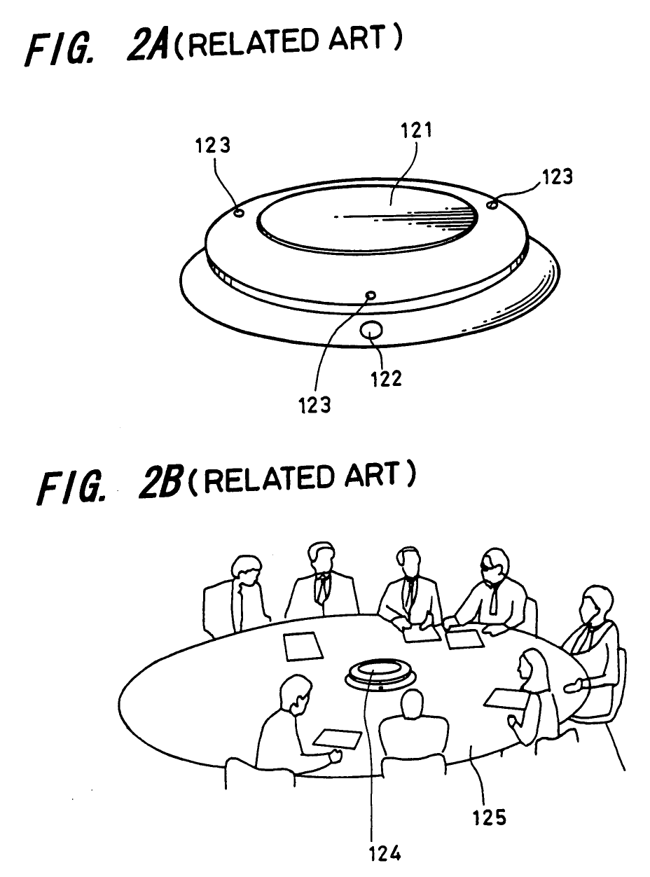

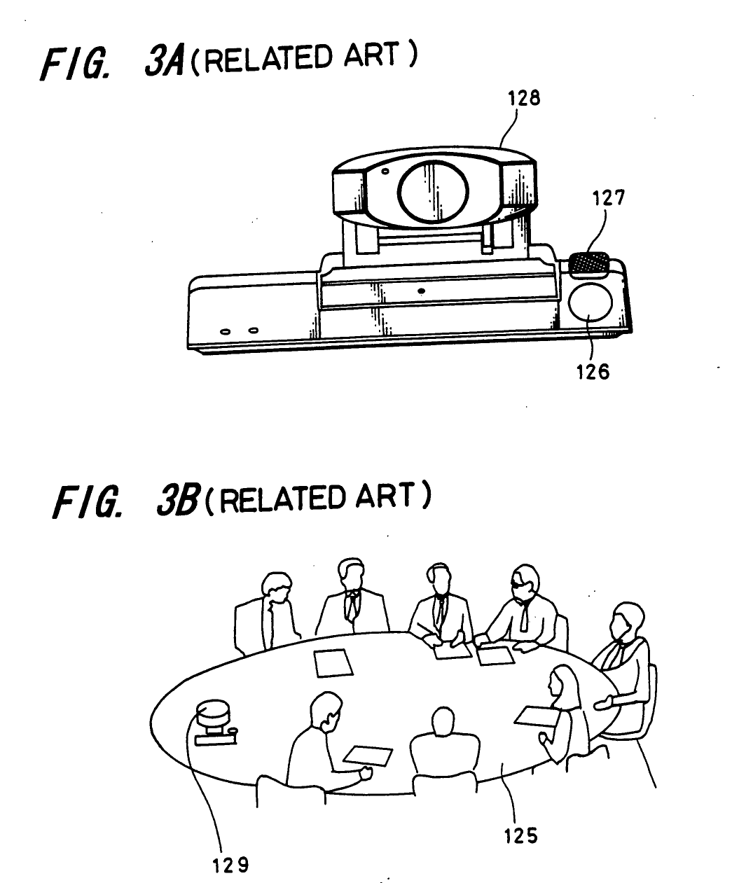

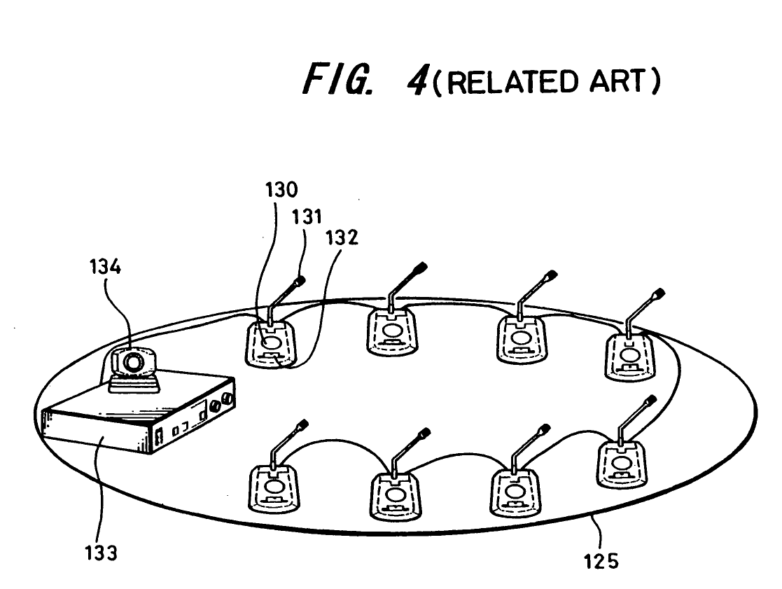

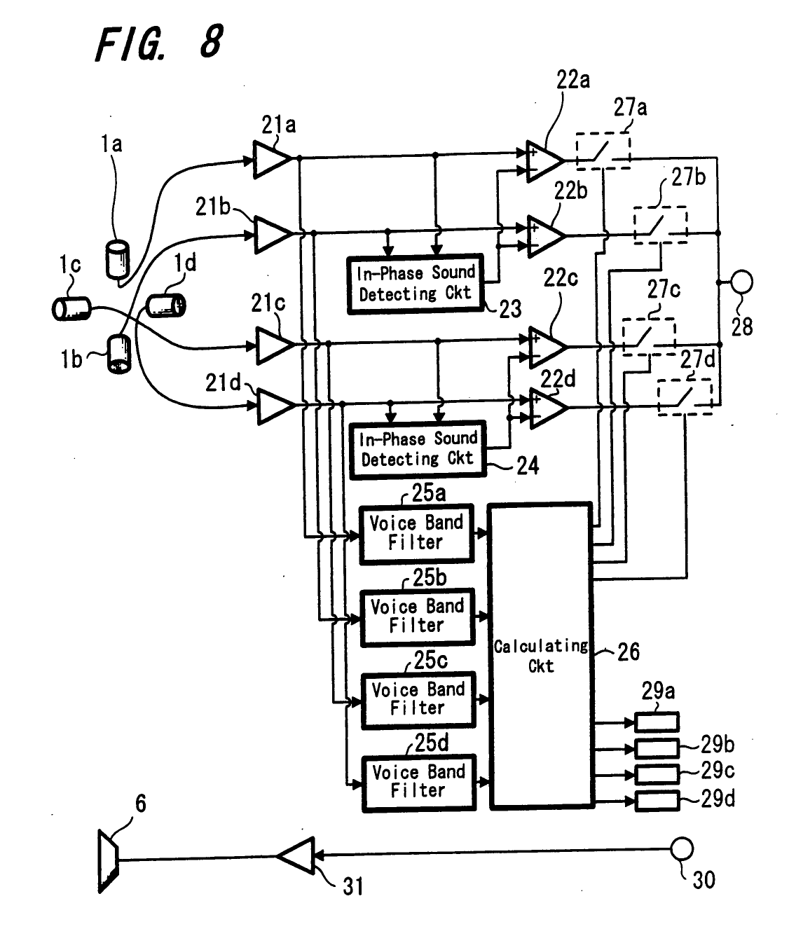

FIG. 8 is a block diagram showing a circuit arrangement of a signal processing system of an audio input and output unit to which the present invention can be applied. This signal processing system is accommodated within a case (not shown) which is externally attached to the microphone/speaker portion shown in FIGS. 2 to 4. Alternatively, as another example, this signal processing system may be accommodated within a space produced in the inside of the enclosure 5 of the microphone/speaker portion shown in FIGS. 5 to 7.

Referring to FIG. 8, sound signals outputted from the microphones 1a, 1b comprising the pair A are supplied to this signal processing system, in which the sound signals are respectively amplified by microphone amplifiers 21a, 21b and supplied to positive (plus) input terminals of subtractors 22a, 22b and also supplied to an in-phase sound detecting circuit 23.

The in-phase sound detecting circuit 23 is a circuit for extracting sound components of the same phase from two sound signals by comparing the levels of the inputted two sound signals, the frequency components of the inputted two sound signals and the phases of the inputted two sound signals, and the circuit may be comprised of a digital filter or an analog filter. Sound component signals extracted by the in-phase sound detecting circuit 23 are supplied to negative (minus) input terminals of the subtractors 22a, 22b.

Sound signals inputted to the microphones 1c, 1d comprising the pair B are respectively amplified by microphone amplifiers 21c, 21d, whereafter they are respectively supplied to positive input terminals of substractors 22c, 22d and an in-phase sound detecting circuit 24.

The in-phase detecting circuit 24 is a circuit having the same circuit arrangement as that of the in-phase sound detecting circuit 23. Sound component signals extracted by the in-phase sound detecting circuit 24 are supplied to negative input terminals of the subtractors 22c, 22d, respectively.

Sound signals outputted from the subtractors 22a to 22d are supplied to switch elements 27a to 27d, respectively. Output terminals of the switch elements 27a to 27d are connected to an audio output terminal 28 of this audio input and output unit. A signal is supplied to control input terminals of the switch elements 27a to 27d from a calculating circuit 26 which will be described later on.

On the other hand, the sound signals outputted from the microphones 1a, 1b comprising the pair A are also supplied through the microphone amplifiers 21a, 21b to voice band filters 25a, 25b, respectively. The sound signals outputted from the microphones 1c, 1d comprising the pair B are supplied through the microphone amplifiers 21c, 21d to voice band filters 25c, 25d, respectively.

The voice band filters 25a to 25d are band-pass filters having a passage of frequency bands of man's voice (100 Hz to 4 kHz). Sound signals that have passed through the voice band filters 25a to 25d are supplied to the calculating circuit 26.

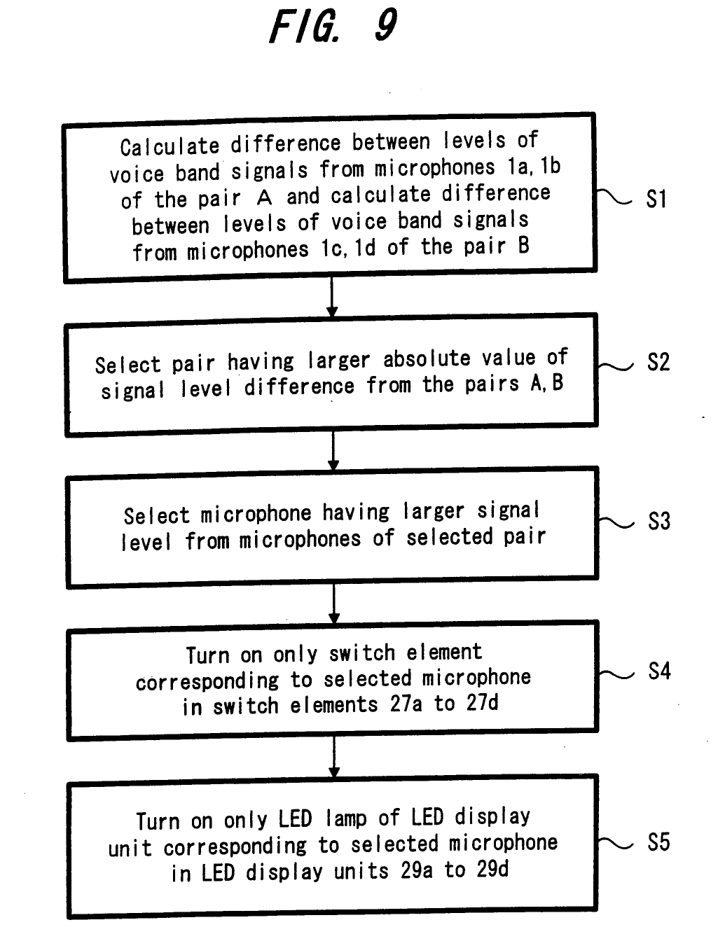

The calculating circuit 26 is a circuit for executing steps shown in FIG. 9 repeatedly. In this processing, first, as shown in FIG. 9, at a first step S1, the calculating circuit 26 calculates a difference between the levels of the sound signals from the voice band filters 25a and 25b (i.e., difference between the levels of the voice band signals from the microphones 1a and 1b comprising the pair A) and also calculates a difference between the levels of the sound signals from the voice band filters 25c and 25d (i.e., difference between the levels of the voice band signals from the microphones 1c and 1d comprising the pair B).

At the next step S2, the calculating circuit 26 decides the pair in which an absolute value of this signal level difference is large by comparing the pairs A and B. Then, control goes to the next step S3, whereat the calculating circuit 26 decides one microphone having the larger signal level by comparing two microphones comprising the pair thus determined.

At the next step S4, of the switch elements 27a to 27d, the calculating circuit 26 supplies a signal to turn on only a switch element corresponding to the microphone thus decided (if the decided microphone is the microphone 1a, for example, then the signal is supplied to only the switch element 27a).

Then, at the next step S5, of the LED (light-emitting diode) units 29a to 29d, shown in FIG. 8, respectively provided on the surface of the case of this audio input and output unit in response to the microphones 1a to 1d, the calculating circuit 26 supplies a signal for turning on the LED to only the LED display unit corresponding to the microphone thus decided.

This calculating circuit 26 may be constituted by combining a plurality of hardware circuits (subtractor, comparator or the like) having functions corresponding to the individual processing steps S1 to S5, respectively or may be constituted by installing software, which is used to execute the steps S1 to S5, on the DSP.

As shown in FIG. 8, an audio signal inputted to an audio input terminal 30 of this audio input and output unit is supplied to the speaker 6 through a speaker amplifier 31.

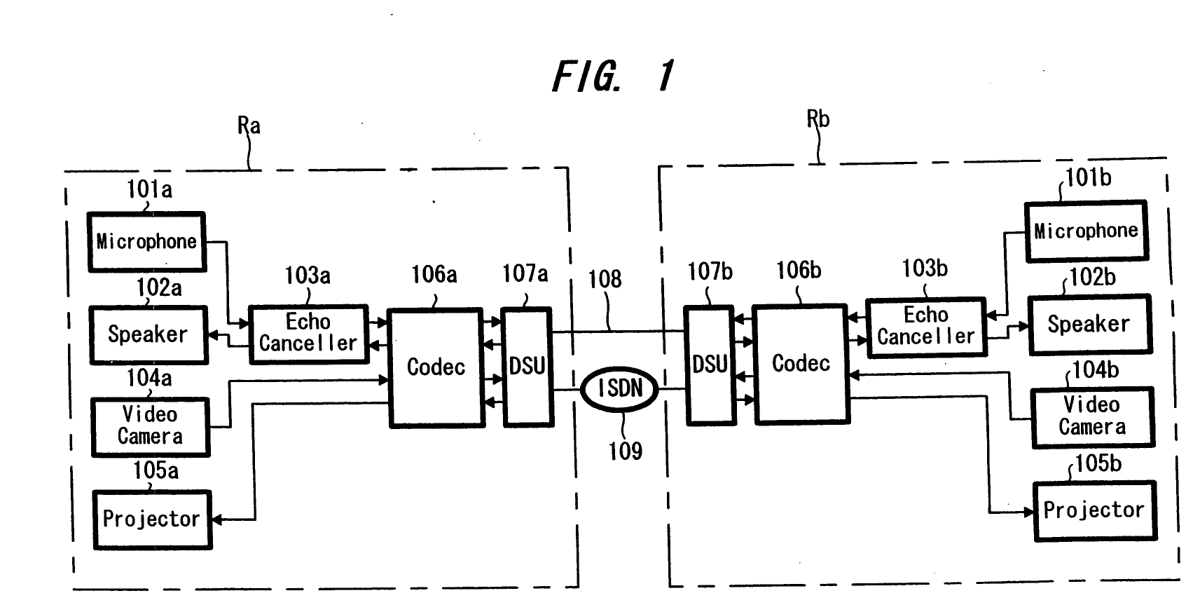

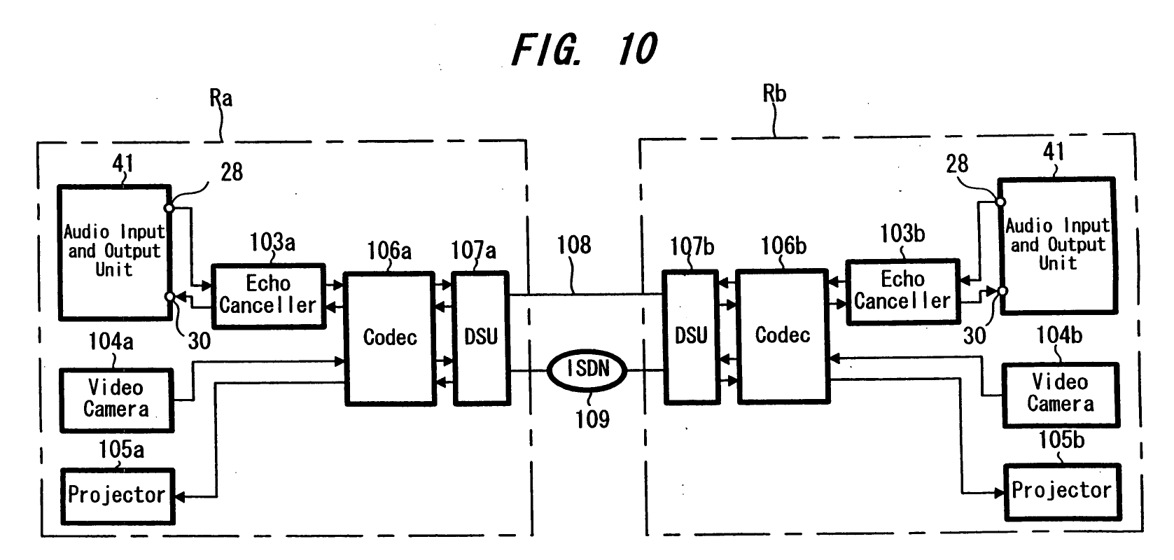

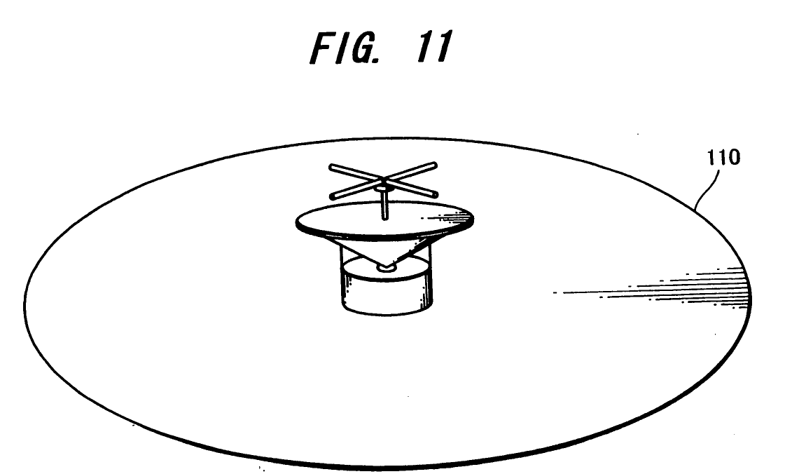

FIG. 10 is a block diagram showing an outline of a videoconferencing system using this audio input and output unit wherein elements and parts identical to those of FIG. 1 are denoted by identical reference numerals.

As shown in FIG. 10, the meeting room Ra is provided with this audio input and output unit 41 and also includes the echo canceller 103a, the video camera 104a, the projector 105a, the codec 106a and the DSU 107a.

The meeting room Rb, which is located at the spot. remote from the meeting room Ra, is also provided with this audio input and output unit 41 and also includes the echo canceller 103b, the video camera 104b, the projector 105b, the codec 106b and the DSU 107b. The DSU 107a and the DSU 107b are connected to each other by the dedicated line 108 or the ISDN 109.

As shown in FIG. 11, in each of the meeting rooms Ra and Rb, the microphone/speaker portion of the audio input and output unit 41 is set at the center of a table 110 where all participants are to be seated.

The audio signal outputted from the audio output terminal 28 of the audio input and output unit 41 located within the meeting room Ra is inputted to the audio input terminal 30 of the audio input and output unit 41 in the meeting room Rb through the echo canceller 103a, the codec 106a, the DSU 107a, the dedicated line 108 or the ISDN 109, the DSU 107b, the codec 106b and the echo canceller 103b, sequentially. The audio signal outputted from the audio output terminal 28 of the audio input and output unit 41 within the meeting room Rb is also inputted to the audio input terminal 30 of the audio input and output unit 41 in the meeting room Ra in the same manner.

Next, the manner in which the meeting is progressing in the videoconferencing system shown in FIG. 10 will be described.

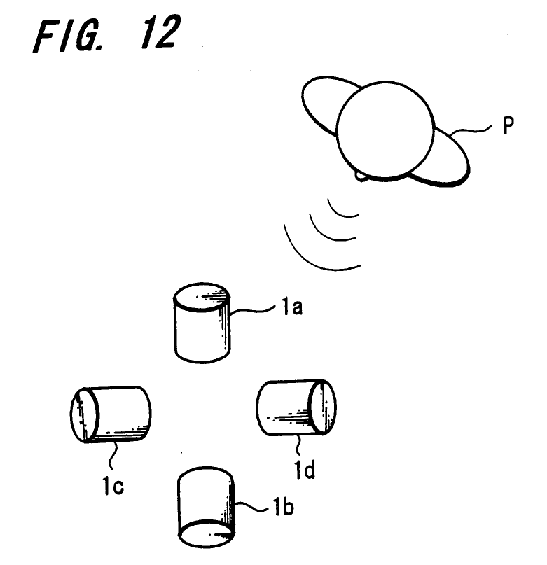

As shown in FIG. 12, for example, let it be assumed that, of participants seated at the table 110 (FIG. 11) within the meeting room Ra, a participant P, who is sitting at the seat closest to the front of the microphone 1a of the microphones 1a to 1d of the audio input and output unit 41, is speaking.

At this time, the voice of this participant P and other background noise are inputted to the respective microphones 1a to 1d of the audio input and output unit 41. Then, the subtractors 22a, 22b and the in-phase sound detecting circuit 23 subtract signals of sound components of the same phase from the outputted audio signals from the microphones 1a, 1b comprising the pair A, whereby a signal of sound components equally inputted to the microphones 1a, 1b (such as sounds of an air-conditioner and radiation fans of the projector 105a which are noises spread to the entire meeting room Ra.) are canceled from the outputted sound signals from the two microphones 1a, 1b which are located in directions with directivity being opposite to each other.

Similarly, the subtractors 22c, 22d and the in-Zphase sound detecting circuit 24 subtract signals of sound components of the same phase from the outputted sound signals from the microphones 1c, 1d comprising the pair B, whereby signals of sounds such as sounds of the air-conditioner and the radiation fans of the projector 105a which are noises spread to the entire meeting room Ra are canceled from the outputted sound signals of the two microphones 1c, 1d located in directions with directivity being opposite to each other.

At that time, since the seat of the participant P is closest to the front of the microphone 1a (that is, the seat most distant from the front of the microphone 1b), a voice of the participant P is collected by the microphone 1a of the microphones 1a to 1d at highest efficiency and is hardly collected by the microphone 1b.

Accordingly, when the calculating circuit 26 executes the calculation processing shown in FIG. 9 based upon the outputted sound signals from the voice band filters 25a to 25d, since the calculating circuit 26 decides the pair A as the pair which has the larger absolute value of the difference between the levels of the voice band signals at the steps S1, S2 and the calculating circuit 26 decides the microphone 1a as the microphone having the higher level of the voice band signal at the step S3, the calculating circuit 26 supplies the signal for turning on only the switch element 27a of the switch elements 27a to 27d at the step S4.

As a result, in the audio input and output unit 41 within the meeting room Ra, the sound that is inputted to the microphone 1a which collects a voice of the participant P at highest efficiency of the microphones 1a to 1d, and that is then subtracted noises spread to the entire meeting room Ra by the subtractor 22a and the in-phase sound detecting circuit 23 is selected to be an inputted voice at the switch elements 27a to 27d, and the signal of the sound thus selected is outputted from the audio output terminal 28.

The speaker 6 of the audio input and output unit 41 within another meeting room Rb can output the sound in which the noise spread to the entire meeting room Ra is canceled from the sound inputted to the microphone 1a of the audio input and output unit 41 within the meeting room Ra.

Thus, the speaker 6 of the audio input and output unit 41 within the meeting room Rb can output a clear voice of the participant P.

Although we have so far described the example in which the participant seated closest to the front of the microphone 1a of the microphones 1a to 1d speaks, the present invention is not limited to the above-mentioned example and the following variant is also possible. When a participant seated closest to the front of the microphone 1b, 1c or 1d speaks or when the participant P continues speaking while moving to a seat closest to the front of the microphone 1b, 1c or 1d, the audio input and output unit 41 within the meeting room Ra may select a sound signal in which the noise spread to the entire meeting room Ra is canceled from the sound inputted to the microphone 1b, 1c or 1d and may output the selected sound signal from the audio output terminal 28 in the same way.

Therefore, the speaker 6 of the audio input and output unit 41 within the meeting room Rb can constantly output a clear voice of a participant in the meeting room Ra.

While we have so far described the example in which a participant within the meeting room Ra spoke, the present invention is not limited to the above-mentioned example. That is, when a participant in the meeting room Rb speaks, the speaker 6 of the audio input and output unit 41 within the meeting room Ra can constantly output a clear voice of the participant who is speaking in the meeting room Rb.

As described above, according to this audio input unit, since the microphone which can collect a voice of a speaker at highest efficiency is decided based upon the difference between the inputted levels of the voice band sound components with respect to two directional microphones comprising each pair A, B and the sound in which the noise spread to the entire meeting room is canceled from the sound inputted to the decided microphone is selected as the inputted sound, the speaker in another meeting room at a remote location can constantly output a clear voice of a participant.

Further, according to this audio input unit, as shown in FIGS. 5 to 7, since the reflective plate 4 having the circular cone shape exists above the speaker 6, the sound upwardly outputted from the speaker 6 are reflected in the horizontal direction by the reflective plate 4. As a consequence, the sound from the speaker 6 can reach the ears of participants without being reflected on the ceiling or walls of the meeting room. From this standpoint, participants are able to catch a clear voice of a participant in another meeting room at the remote location from the speaker 6 as well.

Moreover, according to this audio input unit, as shown in FIGS. 5 to 7, since the shielding plate 3 exists above the reflective plate 4 so as to separate the microphones 1a to 1d and the reflective plate 4, of the sounds reflected on the reflective plate 4, the amount of sounds leaked to the microphones 1a to 1d can be decreased considerably, so that the levels of the sound inputted to the microphones 1a to 1d after outputted from the speaker 6 can be lowered considerably.

In addition, since the microphones 1a to 1d are brought to the same positional relationship relative to the speaker 6, the sounds inputted to the microphones 1a to 1d from the speaker 6 become the sounds having the same phase. Accordingly, the sounds inputted to the microphones 1a to 1d at very low level after outputted from the speaker 6 also can be canceled by the subtractors 22a to 22d and the in-phase sound detecting circuits 23, 24 shown in FIG. 8.

Furthermore, since the audio input and output unit 41 is set at the center of the table 110 as shown in FIG. 11 (i.e., the speaker 6 is located close to each participant), the participant in one meeting room can clearly catch the voice of a participant in another meeting room at the remote location without increasing the level of the sound outputted from the speaker 6. Therefore, from this standpoint, the level of the sound inputted to the microphones 1a to 1d after outputted from the speaker 6 can be further decreased.

Accordingly, echo that is a phenomenon in which the sound inputted to the microphones 1a to 1d of the audio input and output unit 41 in one meeting room is again outputted from the speaker 6 of the audio input and output unit 41 in the same meeting room through the audio input and output unit 41 in another meeting room, and howl caused by the echo can be suppressed considerably without being processed by the echo cancellers 103a, 103b.

As a consequence, since the echo cancellers 103a, 103b are not required to have high capability, a burden imposed when software executed by the DSP comprising the echo cancellers 103a, 103b is developed can be alleviated and the costs of the hardware circuits for use as the echo cancellers 103a, 103b can be decreased as well.

Since the level at which the sound from the speaker 6 is inputted to the microphones 1a to 1d is very low and the audio input and output unit 41 is set at the center of the table 110 at which the participants are seated as shown in FIG. 11 (the microphones 1a to 1d are placed close to each of the participants and the directions in which the microphones 1a to 1d have directivity are faced toward the directions of the participants), the level at which a voice of each participant is inputted to the microphones 1a to 1d may increase as an absolute amount and may also increase relative to the input level of the background noise (sounds from the speaker 6, sounds from the air-conditioner, sounds from the exhaust fan of the projector, etc.). Thus, the microphones 1a to 1d can efficiently collect a voice of the participant.

Next, several modified examples of the audio input and output unit will be described.

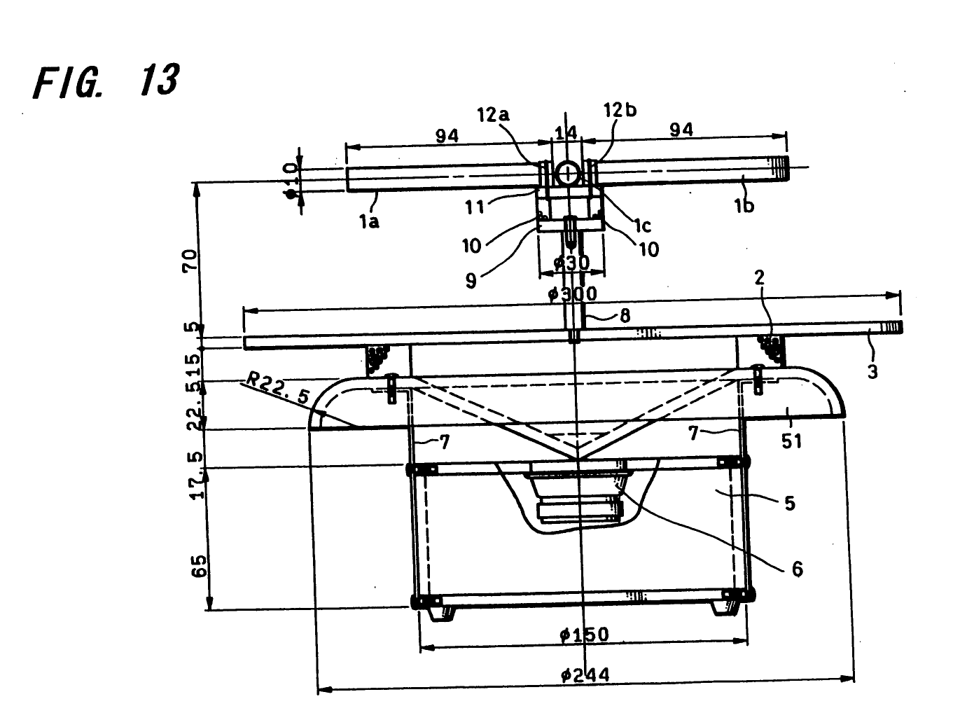

FIG. 13 is a front view (partly in a cross-sectional fashion) showing a first modified example in which the shape of the reflective plate provided above the speaker 6 is changed. In FIG. 13, elements and parts identical to those of FIG. 5 are denoted by identical reference numerals.

In the first modified example, as shown in FIG. 13, instead of the conical reflective plate 4 shown in FIG. 5, a reflective plate 51, in which an edge portion curved in the same direction as the vertex of the circular cone is formed around the conical portion, is attached to the upper end portions of the respective supports 7 by screws in such a manner that the vertex of the circular cone is faced toward the lower direction and that the central axis of the circular cone is nearly aligned with the front axis of the speaker 6. A curvature radius at the edge portion of the reflective plate 51 is approximately 22.5 mm and the length of this edge portion extending along the vertical direction is approximately 22.5 mm as well.

The rest of the portion other than the reflective plate 51 in FIG. 13 has the same structure as that shown in FIG. 5.

According to the first modified example, since the edge portion of the reflective plate 51 covers the speaker 6 like a shade, of sounds reflected on the reflective plate 51, the amount of sounds leaked to the microphones 1a to 1d can further be decreased so that the level of the sounds inputted to the microphones 1a to 1d after outputted from the speaker 6 can further be lowered.

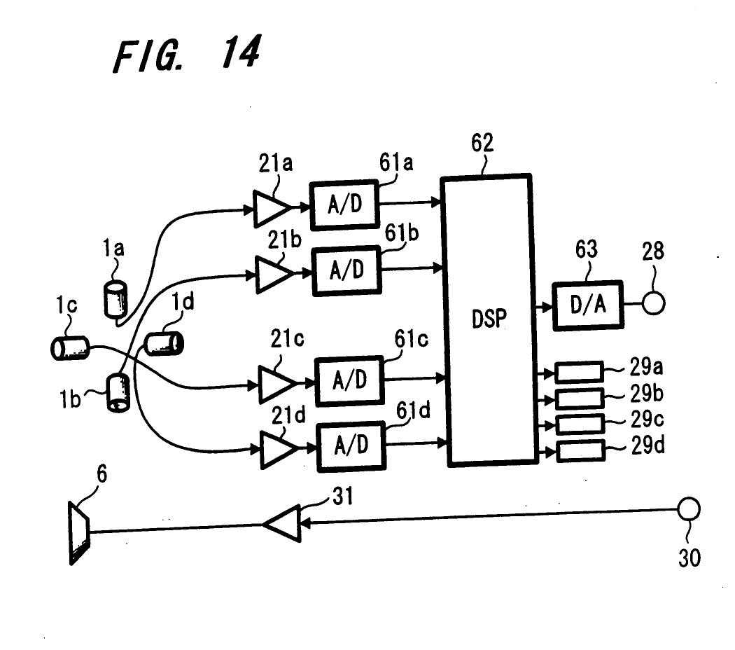

FIG. 14 is a schematic block diagram showing a second modified example in which one DSP may realize all functions of the subtractors 22a to 22d, the in-phase sound detecting circuits 23, 24, the voice band filters 25a to 25d and the switch elements 27a to 27d of the circuit shown in FIG. 8. In FIG. 14, elements and parts identical to those of FIG. 8 are denoted by identical reference numerals.

In the second modified example, the sound signals outputted from the microphones 1a, 1b comprising the pair A are respectively amplified by the microphone amplifiers 21a, 21b and converted into digital signals by A/D (analog-to-digital) converters 61a, 61b, whereafter they are supplied to a DSP 62. The sound signals outputted from the microphones 1c, 1d comprising the pair B are respectively supplied through the microphone amplifiers 21c, 21d and A/D converters 61c, 61d to the DSP 62 as well.

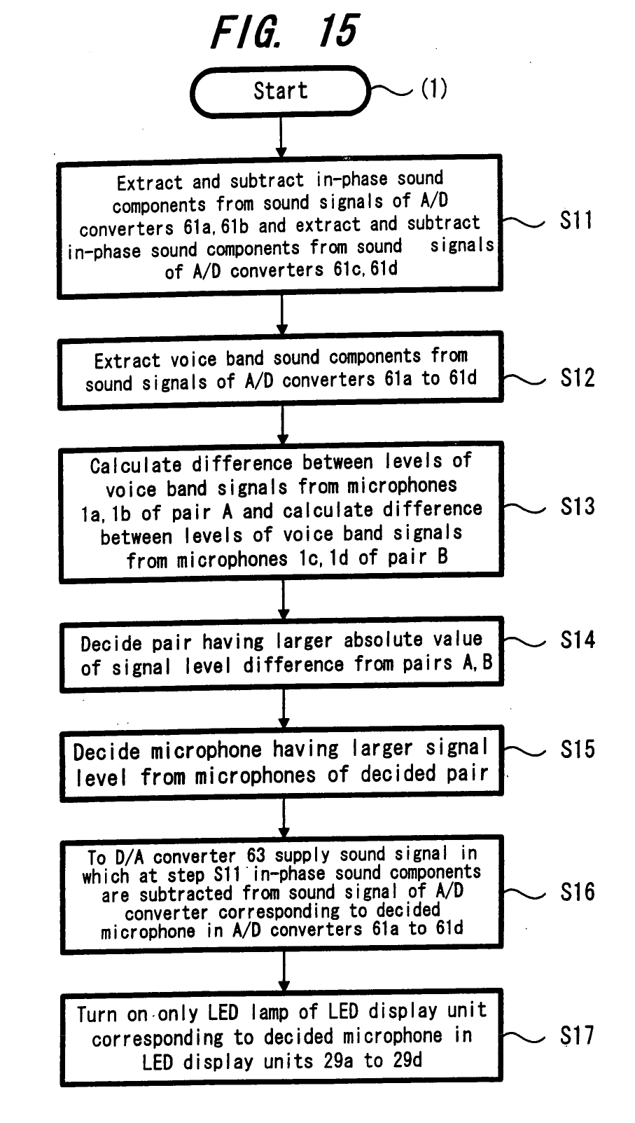

Software for causing the DSP 62 to repeatedly execute processing steps shown in FIG. 15 is installed on the DSP 62. In this processing, first, as the processing corresponding to the functions of the subtractors 22a to 22d and the in-phase sound detecting circuits 23, 24, sound components having the same phase are extracted from the two sound signals supplied from the A/D converters 61a, 61b, and sound components having the same phase are subtracted from the two sound signals. Similarly, sound components having the same phase are extracted from the two sound signals supplied from the A/D converters 61c, 61d and sound components having the same phase are subtracted from the two sound signals at a step S11.

At the next step S12, as the processing corresponding to the functions of the voice band filters 25a to 25d shown in FIG. 8, sound components of the frequency band of man's voice (100 Hz to 4 kHz) are respectively extracted from the sound signals supplied from the A/D converters 61a to 61d.

Subsequently, control goes to steps S13 to S15, whereat the same processing as that of the steps S1 to S3 shown in FIG. 9 is executed as the processing equivalent to the function of the calculating circuit 26 shown in FIG. 8.

At a step S16, as the processing equivalent to the functions of the calculating circuit 26 and the switch elements 27a to 27d shown in FIG. 8, the sound signal whose in-phase sound components had been subtracted at the step S11 from the sound signal transmitted from the A/D converter corresponding to the microphone decided at the step S15 (e.g., when the microphone 1a is decided, that is the A/D converter 61a) is supplied to a D/A converter 63 shown in FIG. 14.

Then, control goes to the next step S17, whereat the DSP 62 executes the same processing as that of the step S5 shown in FIG. 9 equivalent to the function of the calculating circuit 26 shown in FIG. 8.

As shown in FIG. 14, the sound signal that has been supplied to the D/A converter 63 at the processing step S16 of the DSP 62 is converted into an analog signal by the D/A converter 63 and outputted from the audio output terminal 28.

According to the second modified example, since the circuit can be made small in size, the whole audio input and output unit can be reduced in size.

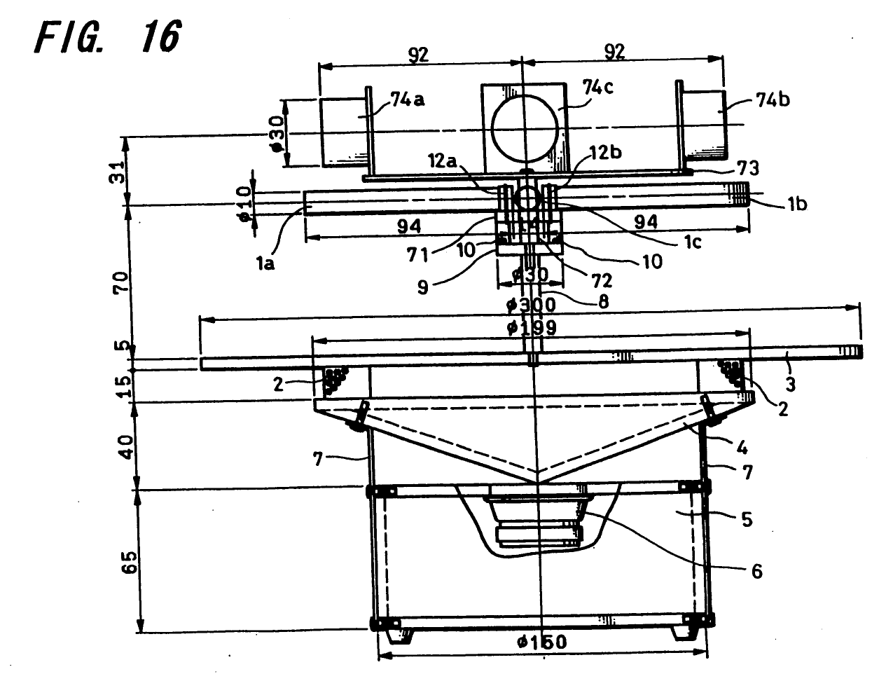

FIGS. 16, 17, 18 and 19 are respectively a front view (partly in a cross-sectional fashion), a plan view, a circuit block diagram and a system block diagram showing a third modified example in which not only the microphones and the speakers but also video cameras are integrally formed as one body of the audio input and output unit. In FIGS. 16, 17, 18 and 19, elements and parts identical to those of FIGS. 5, 6, 8, 10 are denoted by identical reference numerals.

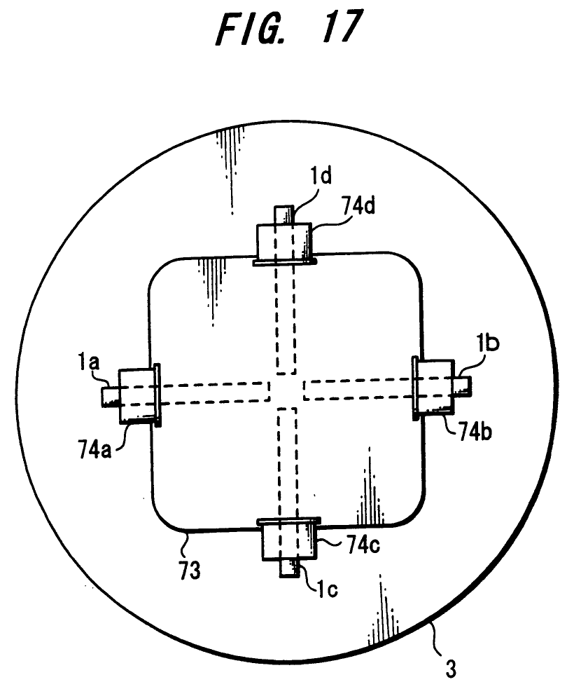

In the third modified example, as shown in FIGS. 16 and 17, instead of the member 11 shown in FIG. 5, a disk-like member 71 having the same structure as that of the member 11 and having a through-hole extended through the central portion of the plate surface is attached to the upper side of the member 9 through the cushion material 10.

A columnar support 72 (made of either resin or metal with rigidity) extended in the vertical direction is attached to the upper side of the member 9 through the through-hole extended through the central portion of the member 71. The upper end portion of the support 71 in the vertical direction has a height higher than those of the microphones 1a to 1d.

A member 73 (made of either resin or metal with rigidity) having approximately a square-like shape is attached to the upper end portion of this support 72. Four CCD (charge-coupled device) cameras 74a to 74d are respectively attached onto this member 73 such that their fronts are faced toward the same directions as those of the microphone 1a to 1d.

The structure of portions other than the member 71, the support 72, the member 73 and the CCD cameras 74a to 74d shown in FIGS. 16 and 17 are the same as those shown in FIGS. 5 and 6.

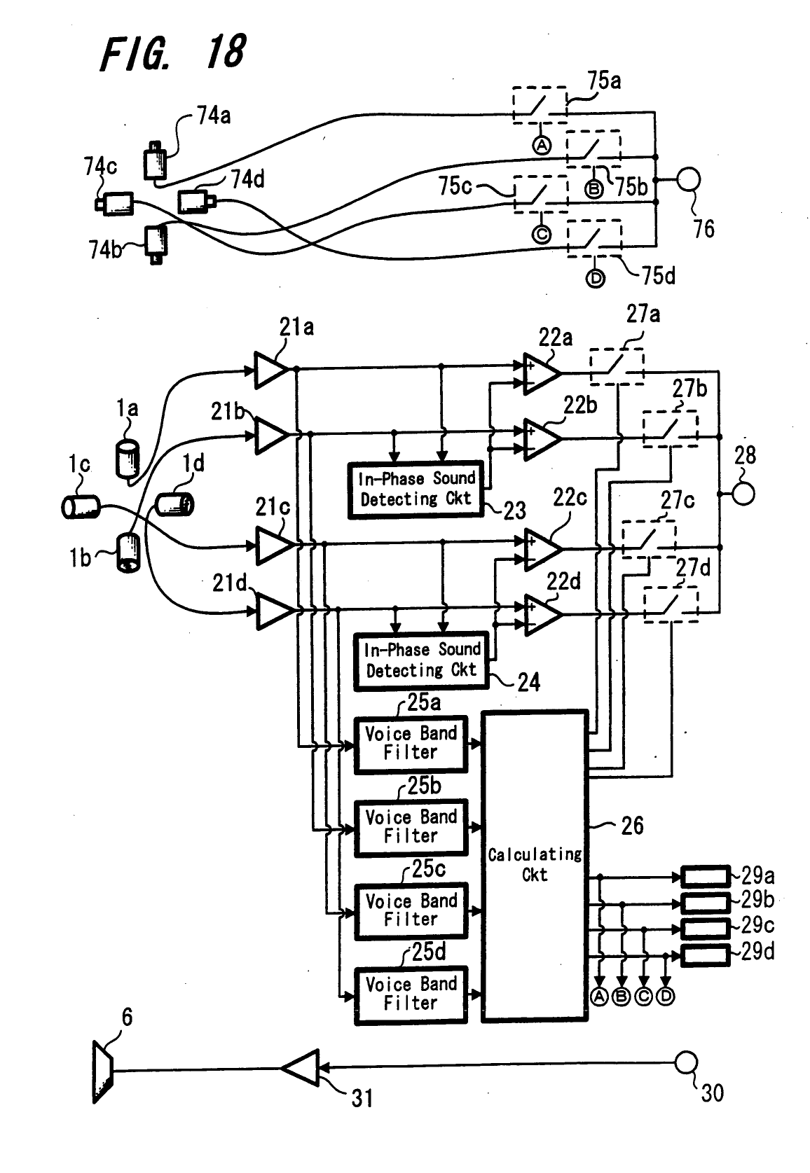

In the third modified example, as shown in FIG. 18, image signals outputted from the CCD cameras 74a to 74d are respectively supplied to switch elements 75a to 75d. Output terminals of the switch elements 75a to 75d are connected to an image output terminal 76 of this audio input and output unit.

The signal supplied from the calculating circuit 26 to the LED display units 29a to 29d to turn on the LED lamps at the step S5 shown in FIG. 9 is also supplied to control input terminals of the switch elements 75a to 75d as signals for turning on the respective switches.

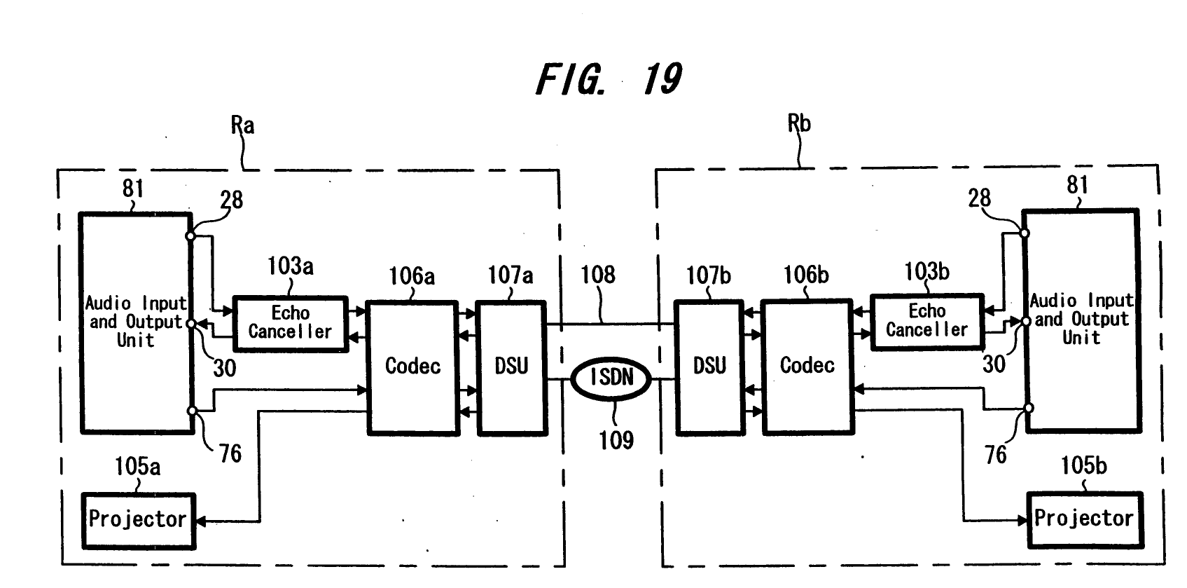

In the third modified example, as shown in FIG. 19, the meeting room Ra includes an audio input and output unit 81 according to the third modified example and further includes the echo canceller 103a, the projector 105a, the codec 106a and the DSU 107a. Another meeting room Rb located at the spot remote from the meeting room Ra also includes the audio input and output unit 81 according to the third modified example and further includes the echo canceller 103b, the projector 105b, the codec 106b and the DSU 107b.

An image signal outputted from the image output terminal 76 of the audio input and output unit 81 within the meeting room Ra is sequentially supplied through the codec 106a, the DSU 107a, the dedicated line 108 or the ISDN 109, the DSU 107b and the codec 106b to the projector 105b in another meeting room Rb. An image signal outputted from the image output terminal 76 of the audio input and output unit 81 within another meeting room Rb is similarly supplied to the projector 105a in the meeting room Ra.

According to the third modified example, when the participant P seated closest to the front of the microphone 1a of the microphones 1a to 1d speaks as shown in FIG. 12, for example, only the switch element 75a in the switch elements 75a to 75d is turned on, whereby the image signal from the CCD camera 74a which is faced to the same direction as the microphone 1a (i.e., the image of participant P is best picked up) is automatically selected from the image signals from the CCD cameras 74a to 74d, then outputted from the audio input and output unit 81 and transmitted to the projector in another meeting room.

As described above, according to the third modified example, the CCD camera in which the speaking participant is best picked up is automatically selected and the picture from the selected CCD camera is projected by the projector in another meeting room.

Therefore, according to the known remote location meeting system in which only one camera is provided in each meeting room, the camera needs to be directed to a currently speaking participant to pick up the image each, time in a manual fashion. According to the third modified example, since such cumbersome operations for manipulating the camera is not required, the meeting will progress more smoothly.

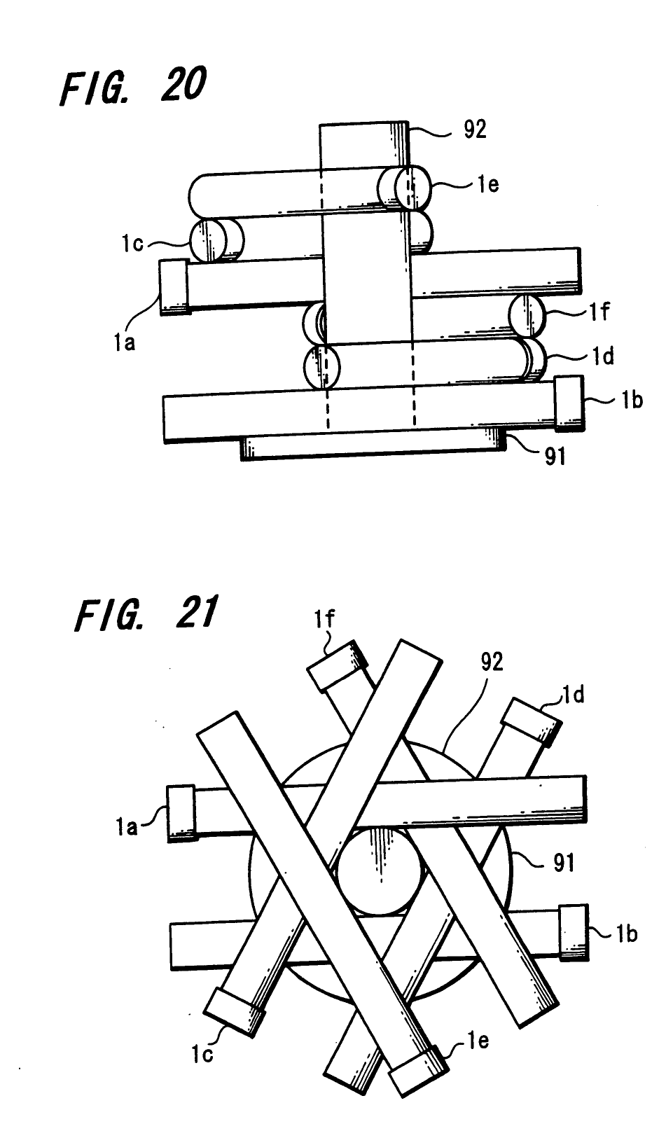

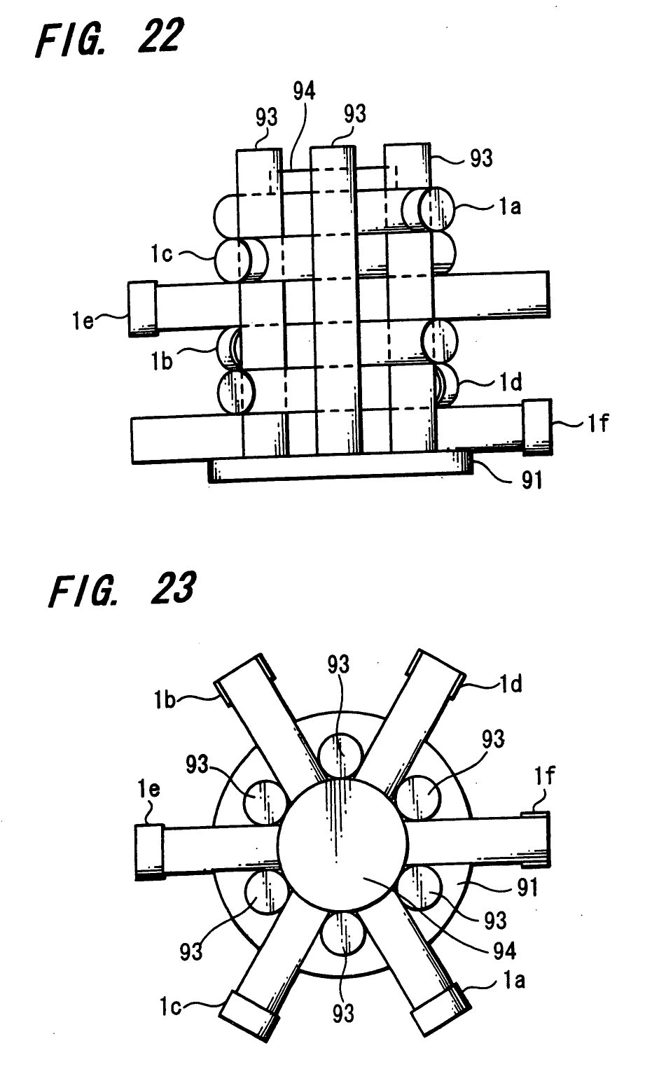

FIGS. 20 and 21 are a front view (partly in a cross-sectional fashion) and a plan view respectively showing a forth example in which the number and the layout of microphones are changed. In FIGS. 20 and 21, elements and parts identical to those of FIGS. 5 and 6 are denoted by identical reference numerals. FIGS. 22 and 23 are a front view (partly in a cross-sectional fashion) and a plan view respectively showing a fifth example in which the number and the layout of microphones are changed. In FIGS. 22 and 23, elements and parts identical to those of FIGS. 5, 6, 20 and 21 are denoted by identical reference numerals.

In the fourth modified example, instead of the member 11 shown in FIG. 5, a disk-like member 91 (made of either resin or metal with rigidity) wider than the member 11 is attached to the upper side of the member 9 through the cushion material 10 (although the portion below the cushion material 10 is not shown in FIGS. 20 and 21, this portion has the same structure as that shown in FIGS. 5 and 6).

A columnar support 92 (made of either resin or metal with rigidity) extending in the vertical direction is attached to the central portion of the plate surface of the member 91. The pair of microphones (aforementioned pair A) comprising the microphones 1a and 1b with directivity being opposite to each other, the pair of microphones (aforementioned pair B) comprising two microphones 1c and 1d with directivity similarly being opposite to each other and the pair of microphones (now referred to as a “pair C”) comprising two unidirectional microphones 1e and 1f of the same type as the microphones 1a to 1d and with directivity being opposite to each other are mounted around the support 92 in such a manner that their directivity are shifted by approximately 60° from each other.

Also in the fifth modified example, instead of the member 11 shown in FIG. 5, the member 91 is attached to the upper side of the member 9 through the cushion material 10 (although the portion below the cushion material 10 is not shown in FIGS. 22 and 23, this portion has the same structure as that shown in FIGS. 5 and 6).

Six columnar supports 93 (made of either resin or metal with rigidity) extending in the vertical direction are attached at equal intervals to the peripheral edge portion of the plate surface of the member 91. The pair of microphones (aforementioned pair A) comprising the microphones 1a and 1b with directivity being opposite to each other, the pair of microphones (aforementioned pair B) comprising the two microphones 1c and 1d with directivity being opposite to each other and the pair of microphones (aforementioned pair C) comprising the two microphones 1e and 1f with directivity being opposite to each other are attached to these supports 93 in such a manner that their directivity are shifted by approximately 60° from each other. A disk-like member 94 is attached to the upper side of the pairs A, B, and C at the positions encircled by the respective supports 93 as a lid.

Although not shown, the signal processing systems of the audio input and output units according to the fourth and fifth modified examples may be constituted in such a manner that the signal processing system shown in FIG. 8, for example, may be changed in response to the three pairs, i.e., the pairs A, B, and C (a microphone amplifier, a subtractor, an in-phase sound detecting circuit, an voice band filter, a switch element and the like for the pair C may be additionally provided and the processing described in FIG. 9 may be executed by the calculating circuit 26 with respect to the three pairs A, B, and C, respectively).

According to the fourth and fifth modified examples, since the number of the microphone pairs increases, even when many participants attend the meeting, it becomes possible to collect voices of the participants more efficiently.

While the present invention has been applied to the audio input and output unit including the signal processing system shown in FIG. 8 in the above-mentioned embodiments, the present invention is not limited to those embodiments and may be applied to an audio input and output unit without such signal processing system (that is, audio input and output unit comprising only the microphone/speaker portion shown in FIGS. 5 to 7).

When the audio input and output unit does not include this signal processing system, the microphones in the microphone/speaker portion may be arranged in such a manner that the microphones may not comprise the pair such as the aforementioned pairs A or B (two microphones are not disposed in directions with directivity being made opposite to each other).

While the microphone/speaker portion is provided with the reflective plate of the circular cone shape in the above-mentioned embodiments, the shape of the reflective plate may be changed freely as long as the reflective plate can reflect sounds from the speaker toward the direction approximately perpendicular to the front axis of the speaker.

While the microphone/speaker portion is provided with the disk-like shielding plate in the above-mentioned embodiments, the shape of the shielding plate may be changed freely as long as the shielding plate can separate the speaker and the microphones from each other (as long as the shielding plate can prevent sounds of the speaker from being leaked to the microphones).

While the reflective plate and the shielding plate are provided in the microphone/speaker portion as the separate members in the above-mentioned embodiments, it is possible to provide one member having both functions of the reflective plate and the shielding plate in the microphone/speaker portion.

While the present invention is used in the videoconferencing system in the above-mentioned embodiments, the present invention can be employed in other remote location conference system than the videoconferencing system.

As described above, according to the audio input unit and the audio input method of the present invention, in the remote location meeting system like the videoconferencing system, another speaker at the remote location can constantly output clear voices of participants and the operations for manipulating the microphones and the work for setting the audio input unit can be prevented from becoming cumbersome for users.

Further, according to the audio input unit and the audio input method of the present invention, since the picture in which the currently speaking participant is best picked up is automatically selected as the inputted picture, the meeting will progress more smoothly.

Furthermore, according to the audio input and output unit of the present invention, in the remote location meeting system like the videoconferencing system, another speaker at the remote location can constantly output clear voices of participants, a cost of the audio input and output unit can be prevented from being increased, the operations for manipulating the microphones, the work for setting the audio input unit can be prevented from becoming cumbersome and a burden and a cost of development of the echo canceller can be decreased.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

1. (canceled)

2. (canceled)

3. (canceled)

4. (canceled)

5. an audio input and output unit comprising:
a plurality of directional microphones disposed above a speaker such that the microphones are faced toward directions with directivity being approximately perpendicular to a front axis of said speaker;
a reflective member provided between said speaker and said purality of directional microphones to reflect sounds outputted from said speaker in the direction approximately perpendicular to said front axis of said speaker; and
a shielding member provided between said speaker and said plurality of directional microphones to separate said speaker and said plurality of directional microphones from each other.

6. The audio input and output unit according to claim 5, wherein:
said reflective member includes a conical member and said conical member is disposed in such a manner that the vertex of the circular cone thereof is faced toward the direction of said speaker and that a central axis of said circular cone is approximately aligned with the front axis of said speaker.

7. The audio input and output unit according to claim 6, wherein:
said plurality of directional microphones comprise a pair of directional microphones disposed in directions with directivity being opposite to each other and said plurality of pairs are located in directions with directivity being shifted from each other.

8. The audio input and output unit according to claim 6, wherein:
said plurality of directional microphones comprise a pair of directional microphones disposed in directions with directivity being opposite to each other and said plurality of pairs are located in directions with directivity being shifted from each other.
